(19) United States
(12) Patent Application Publication
(10) Pub. No.: US 2019/0232842 A1
(43) Pub. Date: Aug. 1, 2019

(54) SEAT ASSEMBLY WITH MASSAGE FEATURE

(71) Applicant: Ford Global Technologies, LLC, Dearborn, MI (US)

(72) Inventors: Daniel Boccuccia, San Francisco, CA (US); Andres Almeida Senatore, Mountain View, CA (US); Hyung Min Baek, Bountiful, UT (US)

(73) Assignee: Ford Global Technologies, LLC

(21) Appl. No.: 15/883,177

(22) Filed: Jan. 30, 2018

(51) Int. Cl. B60N 2/90; A61H 7/00; B60N 2/56

(52) U.S. Cl. CPC B60N 2/976; A61H 7/001; B60N 2/5685; B60N 2/58; A61H 2201/0207; A61H 2205/081; A61H 2201/5035; A61H 2203/0431

(57) ABSTRACT

A seat assembly includes a massage system having first and second frame members spaced-apart from one another. One or more wires interconnect the first and second frame members to define a wire array. The individual wires of the wire array are operable between at-rest and contracted conditions. One or more leads are operably coupled to the one or more wires. The leads supply a current to the one or more wires to heat the wires and move the wires from the at-rest condition to the contracted condition. The wire array can be divided into sections that contract and expand together to provide a massage sequence controlled by a controller in a preprogrammed massage feature.

### FIELD OF THE INVENTION

The present invention generally relates to a seat assembly, and more particularly, to a seat assembly having a lightweight massage feature that has a small footprint with regards to operational componentry.

### BACKGROUND OF THE INVENTION

Massage functionality in automotive seats can be bulky and noisy, which makes it difficult to justify implementation other than in the case of high-end, luxury vehicles. Even in luxury vehicles, most massage systems commercially available today are pneumatically actuated, resulting in an undesired level of noise that is noticeable to vehicle occupants. A new massage system is desired that combines heating and massage features in a single system that address the noise issue and has a low impact on the seat assembly itself.

### SUMMARY OF THE INVENTION

According to one aspect of the present invention, a seat assembly includes a first frame member and a second frame member spaced-apart from one another. One or more wires interconnect the first and second frame members. The wires are operable between at-rest and contracted conditions. One or more leads are operably coupled to the one or more wires. The one or more leads supply a current to the one or more wires to move the wires from the at-rest condition to the contracted condition.

Embodiments of the first aspect of the invention can include any one or a combination of the following features:
respective first and second fabric members operably coupled between the first and second frame members and the one or more wires;
wherein each of the first and second fabric members includes an engagement end coupled to the respective frame member, and an attachment flange coupled to the one or more wires;
wherein each of the one or more wires includes a first end and a second end, wherein the first end is coupled to the attachment flange of the first fabric member, and further wherein the second end is coupled to the attachment flange of the second fabric member;
wherein the first end of each of the one or more wires is coupled to a shank portion of a first wire connector, and further wherein each of the one or more leads is coupled to a shank portion of a second wire connector;
wherein the first and second wire connectors include respective first and second eyelets that are coupled to one another and further coupled to the attachment flange of the first fabric member by a fastener;
wherein the current provided by the one or more leads is transferred to the one or more wires through the first and second wire connectors;
wherein the fastener includes a rivet nut;
wherein the first fabric member is comprised of leather;
wherein the one or more wires includes a plurality of wires defining a wire array substantially covering a support area defined between the first and second support members;
wherein the one or more leads defines a lead array;
wherein each wire of the plurality of wires is independently controlled by an associated lead of the lead array;
including a controller configured to selectively provide current to each wire of the plurality of wires through the associated leads of the lead array to move each wire between the at-rest and contracted conditions in a predetermined sequence; and
wherein each wire of the plurality of wires is heated when the current is applied thereto.

According to another aspect of the present invention, a seat assembly includes a seat cover with first and second support members operably coupled to opposite ends of the seat cover. A wire array interconnects the first and second support members and includes portions thereof operable between at-rest and contracted conditions. A lead array is operably coupled to the wire array. The portions of the wire array move to the contracted condition when a current is applied thereto through the lead array.

Embodiments of the second aspect of the invention can include any one or a combination of the following features:
wherein the first and second frame members are retained in a spaced-apart configuration by respective first and second boundary features respectively incorporated into the opposite ends of the seat cover; and
including a controller configured to selectively provide current to each portion of the wire array to move each portion of the wire array independently between the at-rest and contracted conditions in a predetermined sequence.

According to yet another aspect of the present invention, a seat assembly includes a primary support frame and a secondary support frame coupled to the primary support frame. The secondary support frame includes first and second frame members spaced-apart from one another to define a support area therebetween. A wire array interconnects the first and second frame members. The wire array is defined by a plurality of wires that are operable between at-rest and contracted conditions. A lead array is operably coupled to the plurality of wires and con figured to provide a current thereto. Each wire of the plurality of wires moves to the contracted condition when the current is applied thereto.

Embodiments of the third aspect of the invention can include any one or a combination of the following features:
wherein the primary support frame and the secondary support frame cooperate to surround the support area, and further wherein the support area is positioned on a seatback portion of the seat assembly; and
a support strap having first and second ends disposed on opposite sides of a body portion, wherein the first end is coupled to the first frame member of the secondary support frame and the second end is coupled to the second frame member of the secondary support frame, and further wherein the body portion is disposed along a rear side of the seatback opposite the wire array.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of a seat assembly according to one embodiment of the present invention shown positioned within a vehicle interior;

FIG. 2 is an exploded top perspective view of a seatback;

FIG. 3 is a perspective view of the seatback of FIG. 2 as assembled with a seat cover removed therefrom to reveal a wire array;

FIG. 4A is a front elevational view of a seatback having a wire array with wires in an at-rest condition;

FIG. 4B is a front elevational view of the seatback of FIG. 4A showing select wires of the wire array in contracted conditions;

FIG. 5 is a top perspective view of a seat assembly having primary and secondary support frames along with a wire array positioned over a cushion assembly;

FIG. 6 is a side elevational view of a wire connected to a lead by wire connectors coupled to a fabric member;

FIG. 7 is a fragmentary top perspective view of one side of a seatback having a secondary support frame with a fabric member coupled thereto and a wire array coupled to the fabric member;

FIG. 8 is a fragmentary top perspective view of one side of a seatback having a wire array coupled to a fabric member, wherein one or more of the wires of the wire array are insulated;

FIG. 9A is a front elevational view of a seatback and a secondary support frame with a support strap coupled thereto; and

FIG. 9B is a rear perspective view of the seatback of FIG. 9A.

### DETAILED DESCRIPTION OF THE PREFERRED EMBODIMENTS

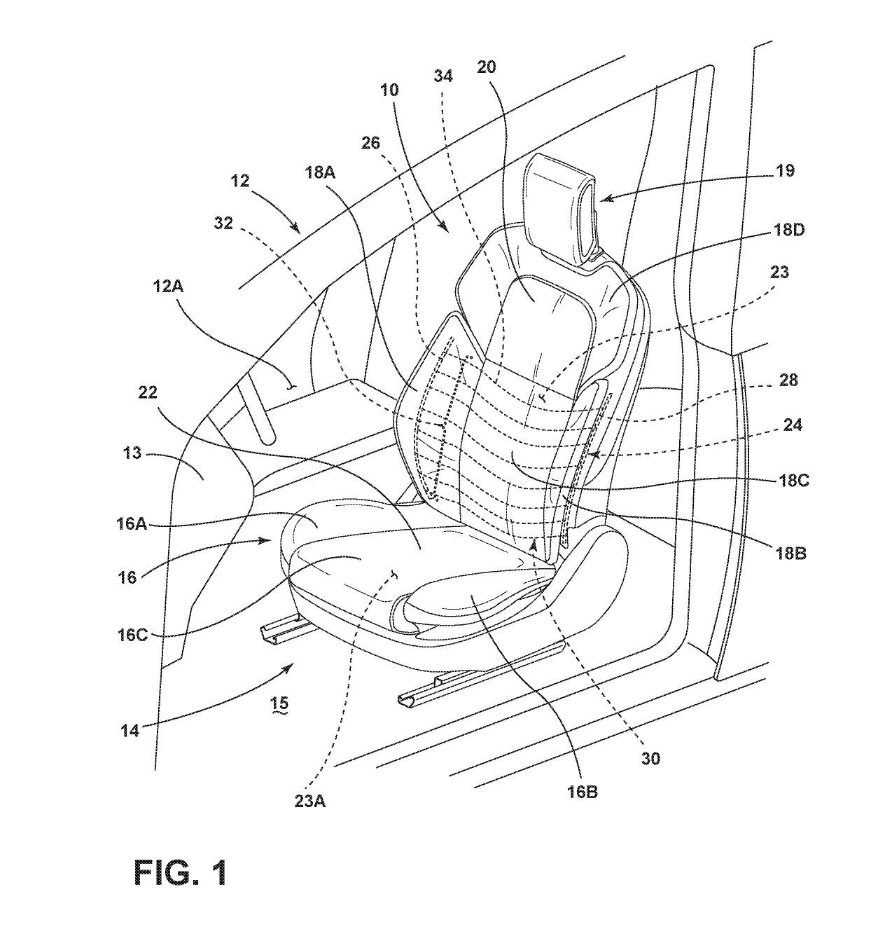

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to FIG. 1, a seat assembly 10 is shown disposed within an interior 12A of a vehicle 12. Specifically, the seat assembly 10 is disposed within the vehicle interior 12A adjacent to an instrument panel or dashboard 13. In FIG. 1, the seat assembly 10 is positioned in a driver's side seating area. However, it is contemplated that the seat assembly 10, or various components and features thereof, can be disposed in other seat assemblies positioned in other areas of a vehicle interior, such as the passenger side seating area, a rear seating area, or a third row seating option. The seat assembly 10 is supported on a track system 14 disposed on a vehicle floor support surface 15, and generally includes a substantially horizontal seat portion 16 and a substantially upright seatback 18. A headrest assembly 19 is disposed near an upper collar portion 18D of the seatback 18. It is contemplated that the seatback 18 is a pivoting member configured for pivotal movement relative to the seat portion 16. The seat portion 16 generally includes a central support portion 16C having protruding fins or side bolsters 16A, 16B disposed on opposite sides thereof. The side bolsters 16A, 16B are separated or spaced-apart from one another by the central support portion 16C and are generally disposed at an inward angle directed towards the central support portion 16C. The side bolsters 16A, 16B are configured to provide support for a vehicle occupant as seated in the seat assembly 10 when the vehicle 12 is in motion. Similarly, the seatback 18 includes side bolsters 18A, 18B, the upper collar portion 18D and a central support portion 18C. The side bolsters 18A, 18B and the upper collar portion 18D are generally angled towards the central support portion 18C of the seatback 18.

The various parts of the seat portion 16 and seatback 18 shown in FIG. 1 are covered with upholstered seat covers 20, 22, respectively. Specifically, seat cover 20 is shown disposed over the seatback 18, while seat cover 22 is shown disposed over the seat portion 16. The seat covers 20, 22 cover various support and frame materials of the seat assembly 10, such as cushion assemblies 23, 23A in the seatback 18 and seat portion 16. The cushion assemblies 23, 23A provide increased cushioned support for a vehicle occupant in both the seat portion 16 and the seatback 18. The seat covers 20, 22 are contemplated to be comprised of a suitable natural or synthetic material, or any combination thereof, that generally covers the cushion assemblies 23, 23A and frame components of the seat assembly 10. In the embodiment shown in FIG. 1, the seat assembly 10 includes a massage system 24 having first and second support members 26, 28 spaced-apart from one another with a wire array 30 disposed therebetween. The wire array 30 is comprised of and defined by a plurality of wires 32, wherein individual wires 34 of the wire array 30 are spaced-apart from one another and substantially cover the central support portion 18C of the seatback 18 in a horizontal manner. It is contemplated that any number of individual wires 34 may be used to define the wire array 30 within the massage system 24. It is also contemplated that massage system 24 and the wire array 30 may be positioned on the seat portion 16, as further described below.

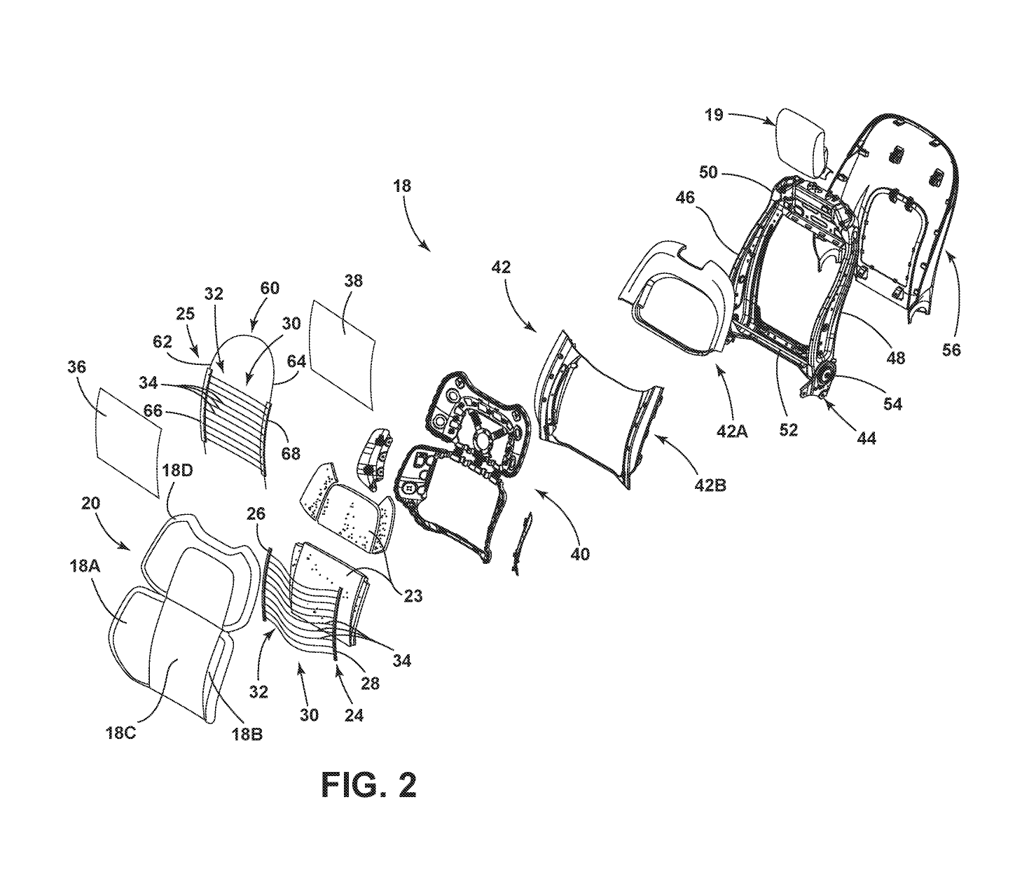

Referring now to FIG. 2, the seatback 18 is shown in an exploded view. In FIG. 2, the seat cover 20 is shown having the necessary contours to cover the seatback 18 at the side bolsters 18A, 18B, the upper collar portion 18D and the central support portion 18C. The massage system 24 is shown as being positioned between the seat cover 20 and the cushion assembly 23. Another embodiment of a massage system 25 is shown in FIG. 2 as an alternative to the massage system 24. The alternate functions of the massage systems 25 and 24 are further described below, and similar components of the massage systems 24, 25 are described herein using like reference numerals. The seatback 18 further includes a seatback suspension system 40 that is supported on upper and lower portions 42A, 42B of a seatback carrier 42. The seatback assembly 18 further includes a primary support frame 44 having first and second side members 46, 48 and upper and lower across members 50, 52 which interconnects the first and second side members 46, 48. In assembly, the primary support frame 44 is a rigid structure that supports the components of the seatback 18. A recliner mechanism 54 is identified on the primary support frame 44 and may be used as a feature to recline the seatback 18 relative to the seat portion 16 of the seat assembly 10 (FIG. 1). As further shown in FIG. 2, the seatback 18 further includes a closeout rear panel 56 that is coupled to the primary support frame 44 in assembly.

With further reference to FIG. 2, the massage system 25 includes a secondary support frame 60 having first and second frame members 62, 64 with fabric members 66, 68 coupled thereto. The secondary support frame 60 may include a steel bar that is bent into an inverted U-shaped configuration, wherein the first and second frame members 62, 64 provide the legs of the inverted U-shaped bar. The fabric members 66, 68 may include any type of fabric suitable to provide a robust coupling feature for the individual wires 34 of the wire array 30, such as leather or cloth material. As shown in FIG. 2, the individual wires 34 of the wire array 30 interconnect the first and second frame members 62, 64 as coupled to the first and second fabric members 66, 68, much like the individual wires 34 of the wire array 30 interconnect the first and second support members 26, 28 in the massage system 24.

As further shown in FIG. 2, insulating members 36, 38 of heat resistant fabric are positioned on opposite sides of the wire array in massage system 25. The insulating members 36, 38 are shown as sheets of heat resistant fabric configured to sandwich the wire array 30 on front and rear sides to thermally insulate the seatback 18 and a seat occupant from heat produced by the wires 34 during contraction. The insulating members 36, 38 can be used with any massage system disclosed herein, including massage systems positioned within the seat portion 16 of the seat assembly 10.

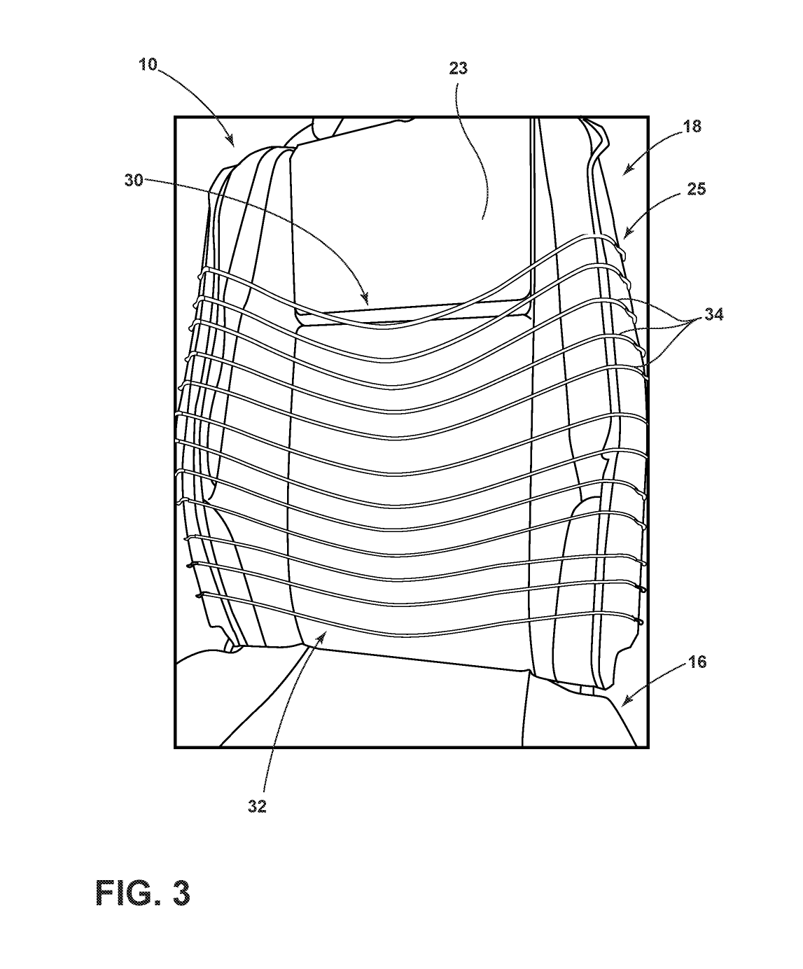

Referring now to FIG. 3, the seatback 18 is shown with the seat cover 20 removed therefrom to expose the cushion assembly 23. In the embodiment shown in FIG. 3, massage system 25 includes a wire array 30 which is disposed over the cushion assembly 23 and wrapped around a front portion thereof. The individual wires 34 of the wire array 30 are shown in FIG. 3 in an at-rest condition, but are configured to be operable between the at-rest condition and a contracted condition. This is due to the individual wires 34 of the wire array 30 being shape memory alloy (SMA) wires that thermally actuate when exposed to an electric current. SMA wires contract to the contracted condition when exposed to a current, and return to their original lengths in the at-rest when the current is removed. The operability of the wires 34 to contract provides for a massage feature of the massage system 25 as select portions of the wire array 30 contract in a preprogrammed sequence providing a massage function. Thus, the contraction of the wires 34 provides the force necessary for the massage system 25 to provide a heated massage to a seat occupant. As the wires 34 cool, the wires 34 expand or otherwise revert back to their at-rest conditions. When the current is applied to the wires 34, the wires 34 are ohmically heated to a temperature that may, for example, be in a range of about 73° C. to about 93° C. This will cause the wires 34 to shrink or contract. The level of contraction may be in a range from about 2% to about 15% of the at-rest length of the wires 34. In order to provide the contraction levels noted above, a current of approximately 0.2 to about 0.66 amps is applied to the wires 34. In this way, the wires 34 can exert a force of about 1-4 lbf in providing a massage function. The actuation of the wires from the at-rest condition to the contracted condition is a silent actuation, making the massage system 25 of the current invention ideal for use in a seat assembly. The wires 34 may be comprised of Nitinol or Dynally SMA wires.

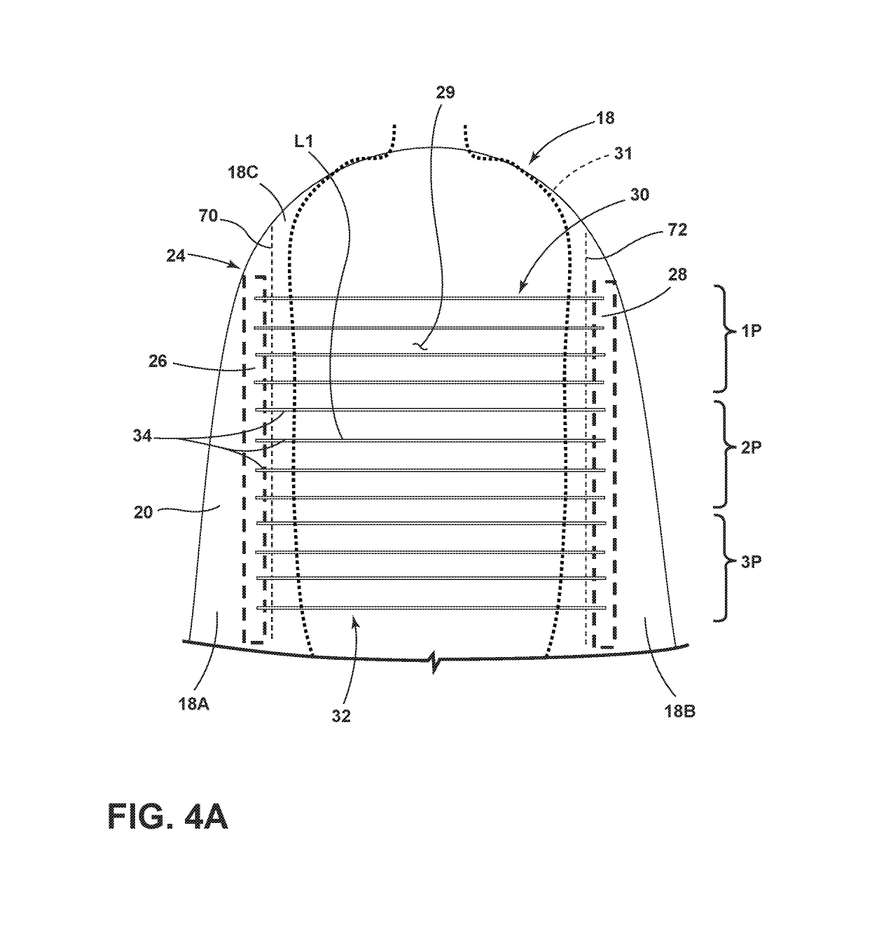

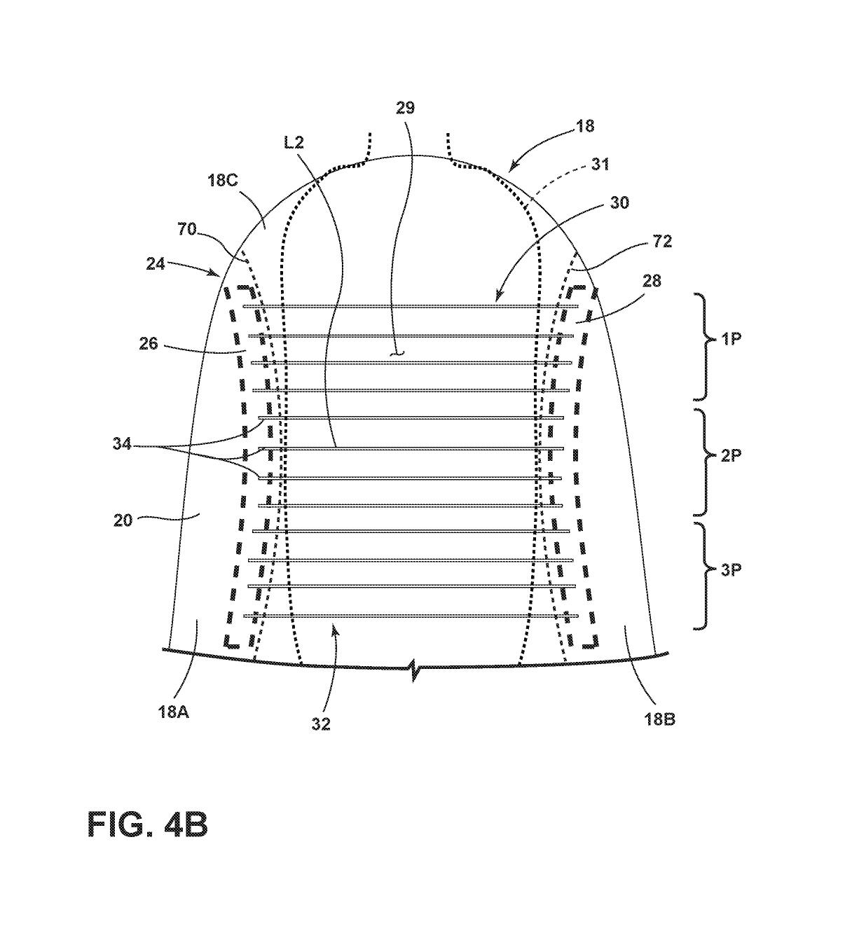

Referring now to FIG. 4A, the massage system 24 is shown positioned within the seatback 18 with seat cover 20 disposed over the seatback 18 and the massage system 24. The first and second support members 26, 28 are shown in a spaced-apart relationship to define a support area 29 therebetween. The wires 34 of the wire array 30 interconnect the first and second support members 26, 28. The wire array 30 substantially covers the support area 29 for supporting a seat occupant 31 thereon, as shown in phantom in FIG. 4A. The first and second support members 26, 28 are contemplated to be polymeric members that are retained in the spaced-apart relationship during the expanding and contracting of the wires 34 of the wire array 30. The retention of the first and second support members 26, 28 in the spaced-apart relationship is enhanced by first and second boundary features 70, 72 respectively incorporated into opposite ends of the seat cover 20. As shown in FIG. 4A, the first and second boundary features 70, 72 partition the seat cover 20 to follow the component parts 18A, 18B and 18C of the seatback 18. It is contemplated that the first and second boundary features 70, 72 may be stitched lines, wherein the first boundary feature 70 retains the first support member 26 in the first side bolster 18A, and further wherein the second boundary feature 72 retains the second support member 28 in the second side bolster 18B. Specifically, the first support member 26 may be sewn to an underside of the seat cover 20, and the second support member 28 may be sewn to an underside of the seat cover 20 by the second boundary member 72. In FIG. 4A, the wires 34 of the wire array 30 are shown in an at-rest condition at a length L1. Further, the wires 34 of the wire array 30 are separated into upper, middle and lower sections 1P, 2P, and 3P, respectively. The separation of the wire array 30 into the upper, middle and lower sections 1P, 2P, and 3P is exemplary only, and it is contemplated that the wire array 30 can be separated into any number of sections. Further, the massage system 24 can include a wire array 30 that provides for individual control over each wire 34 individually for offering highly customized massage sequences.

Referring now to FIG. 4B, the wire array 30 is shown with middle section 2P in a contracted condition as compared to upper and lower sections 1P, 3P shown in at-rest conditions. Thus, it is contemplated that the sections 1P, 2P, and 3P of the wire array 30 can be individually controlled to provide sequential contraction or random contraction according to a massage sequence that is contemplated to be a preprogram massage sequence controlled by a controller 122 (FIG. 6). As shown in FIG. 4B, while the wires 34 of the middle section 2P of the wire array 30 are contracted, the first and second support members 26, 28 remaining in a spaced-apart relationship given the first and second boundary feature 70, 72 incorporated into the seat cover 20. The wires 34 of section 2P have contracted to a length of L2, wherein L2 is a length that is less than L1 shown in FIG. 4A. This is due to a current being selectively applied to the wires 34 of section 2P. It is further contemplated that the wires 34 of section 2P are configured at a first temperature in the at-rest condition shown in FIG. 4A, and then heated to a second temperature (that is greater than the first temperature) to contract the wires 34 of section 2P to the contracted condition shown in FIG. 4B.

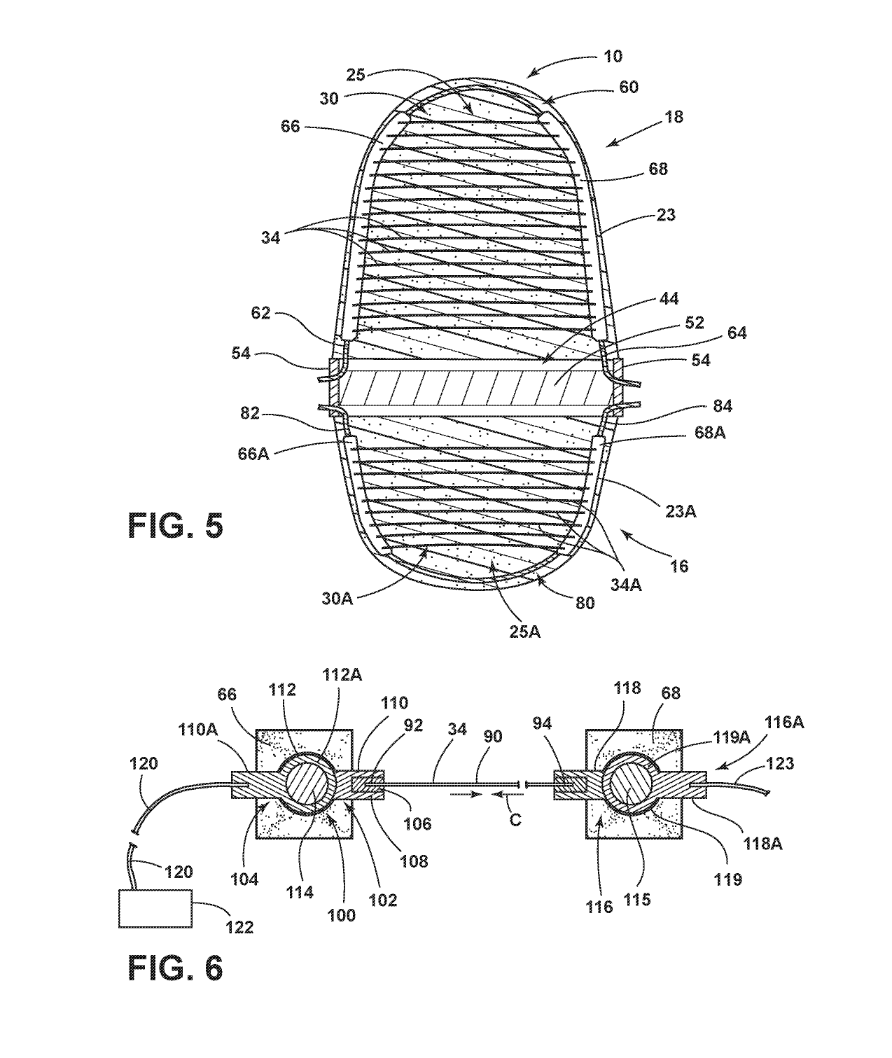

Referring now to FIG. 5, the secondary support frame 60 is shown disposed over the cushion assembly 23 at a front side thereof within the seatback 18. The first and second frame members 62, 64 are shown in a spaced-apart configuration with fabric members 66, 68 coupled thereto. The wire array 30 of massage system 25 is shown interconnecting the first and second frame members 62, 64 as coupled to the first and second fabric members 66, 68. The first and second frame members 62, 64 are supported in the spaced-apart relationship shown in FIG. 5 by the rigid nature of the secondary support frame 60 being comprised of a steel rod material. The spaced-apart relationship of the first and second frame members 62, 64 may be further maintained by a support strap coupled to the secondary support frame 60 as shown and described below with reference to FIGS. 9A and 9B. In FIG. 5, the first and second frame members 62, 64 are interconnected with the primary support frame 44 near the recliner mechanism 54 and/or the lower cross member 52. It is contemplated that the first and second frame members 62, 64 may connect to the primary support frame 44 at any location on the primary support frame 44 to add structural rigidity to the secondary support frame 60. The first and second frame members 62, 64 may connect to the primary support frame 44 at mounting apertures disposed in the primary support frame 44 and can then be welded thereto.

As further shown in FIG. 5, a secondary support frame 80 is shown disposed over the cushion assembly 23A of the seat portion 16. The secondary support frame 80 includes first and second frame members 82, 84 which are shown in a spaced-apart configuration with first and second fabric members 66A, 68A coupled thereto. A wire array 30A of a massage system 25A is shown interconnecting the first and second frame members 82, 84 as coupled to the first and second fabric members 66A, 68A. The first and second frame members 82, 84 are supported in the spaced-apart relationship shown in FIG. 6 by the rigid nature of the secondary support frame 80 being comprised of a steel rod material. The spaced-apart relationship of the first and second frame members 82, 84 may also be maintained on the seat portion 16 of the seat assembly 10 by a support strap, as further discussed below. Thus, the seat assembly 10 shown in FIG. 6 includes a massage system 25 for the seatback 18, as well as a massage system 25A for providing a massage feature to the seat portion 16. While massage system 25 is shown on the seatback 18 and massage system 25A is shown on the seat portion 16, it is contemplated that either the seatback 18 or the seat portion 16 may include a massage system akin to the massage system 24 described above as well.

Referring now to FIG. 6, a wire 34 is shown having a body portion 90 with first and second ends 92, 94. The first end 92 is shown coupled to a wire connector assembly 100. Specifically, the first end 92 of the wire 34 is coupled to a first wire connector 102. As shown in FIG. 6, the first end 92 of the wire 34 is coupled to a ferrule member 106 disposed in a relief portion 108 of a shank portion 110 of the first wire connector 102. The first wire connector 102 further includes an eyelet 112 which is coupled to an eyelet 112A of a second wire connector 104. The eyelets 112, 112A of the first and second wire connectors 102, 104 are further coupled to a fabric member 66 via a fastener 114. It is contemplated that the fastener 114 may be a rivet nut fastener. The first and second wire connectors 102, 104 of the wire connector assembly 100 are contemplated to be metallic members that are capable of conductively passing a current therebetween. The current is supplied by a lead wire 120 to the wire connector assembly 100, and then to the wire 34. The lead wire 120 is coupled to the second wire connector 104 of the wire connector assembly 100 at a shank portion 110A thereof. As noted above, when the current is supplied to the wire 34, the wire 34 contract at the body portion 90 thereof direction as indicated by arrows C. In this way, the contraction of the wire 34 provides a force which is experienced by seat occupant during a massage sequence. The current from the lead wire 120 is selectively provided by a controller 122 in a predetermined sequence, wherein the controller 122 may include any number of predetermined sequences to provide various massage side effects for the massage system 24, 25. The lead wire 120 in FIG. 6 is one of numerous lead wires that are each associated with an individual wire 34 of the wire array 30 of either of the massage systems 24, 25, such that the individual wires 34 can contract individually with respect to adjacent wires 34 of the wire array 30. As further shown in FIG. 6, the second end 94 of the wire 34 is coupled to fabric member 68 by a wire connector 116 having a shank portion 118 and an eyelet portion 119. The wire connector 116 is coupled to the fabric member 68 by a fastener 115, which may be a rivet nut fastener. The second end 94 is further coupled to a ground wire 123 through another wire connector 116A having a shank portion 118A and an eyelet 119A. While the wire 34 of FIG. 6 is shown coupled to the fabric members 66, 68 it is contemplated that the wires 34 are also coupled to the polymeric support members 26, 28 in a similar manner using rivets and wire connectors in massage system 24.

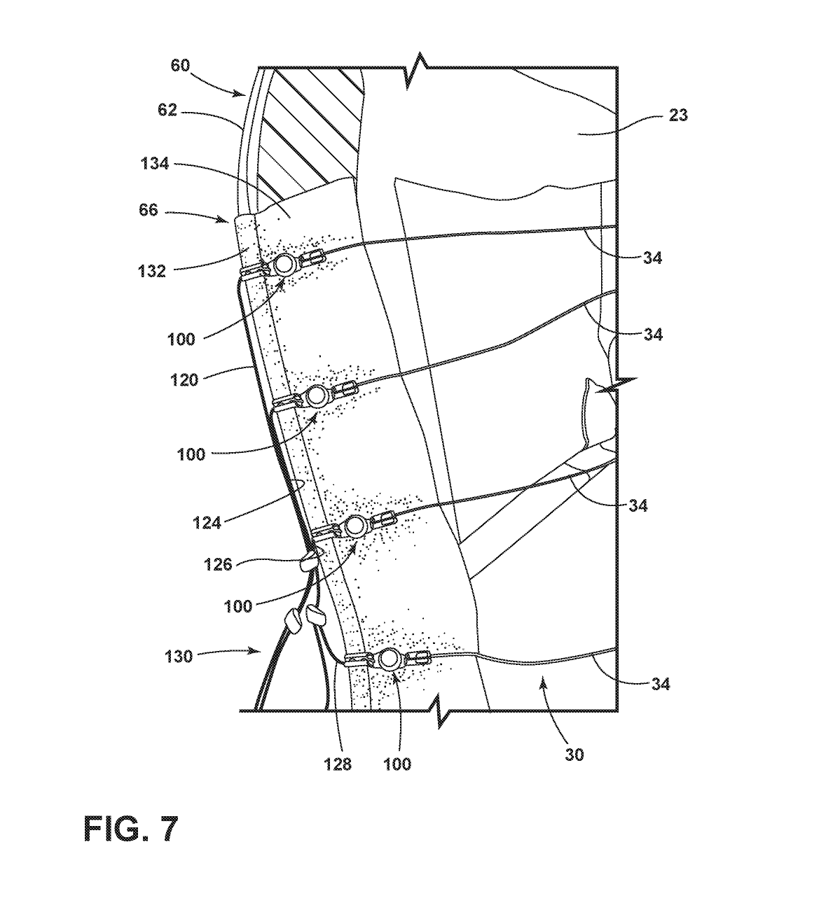

Referring now to FIG. 7, a lead array 130 is shown having lead wires 120, 124, 126 and 128 which are associated with individual wires 34 of the wire array 30. The lead array 130 is operably coupled to the controller 122 (FIG. 6) for selectively providing current to the wires 34 of the wire array 30 for contraction of the same. In the embodiment shown in FIG. 7, the fabric member 66 is shown coupled to the first frame member 62 of the secondary support frame 60 at an engagement end 132 of the fabric member 66 which is wrapped around the first frame member 62. It is contemplated that the engagement end 132 of the fabric member 66 may be sewn to the first frame member 62. An attachment flange 134 extends outwardly from the engagement end 132 of the fabric member 66 to which the wire connector assemblies 100 are coupled to securely fasten the wires 34 to the associated leads 120, 124, 126 and 128, and further securely couple the wire array 30 the fabric member 66. Using a robust material, such as leather, the fabric member 66 provides for a structurally sound attachment location for the wire array 30 to interconnect the wire array 30 with a rigid structure at the secondary support frame 60 as the wires 34 expand and contract during a massage sequence predicated by the controller 122.

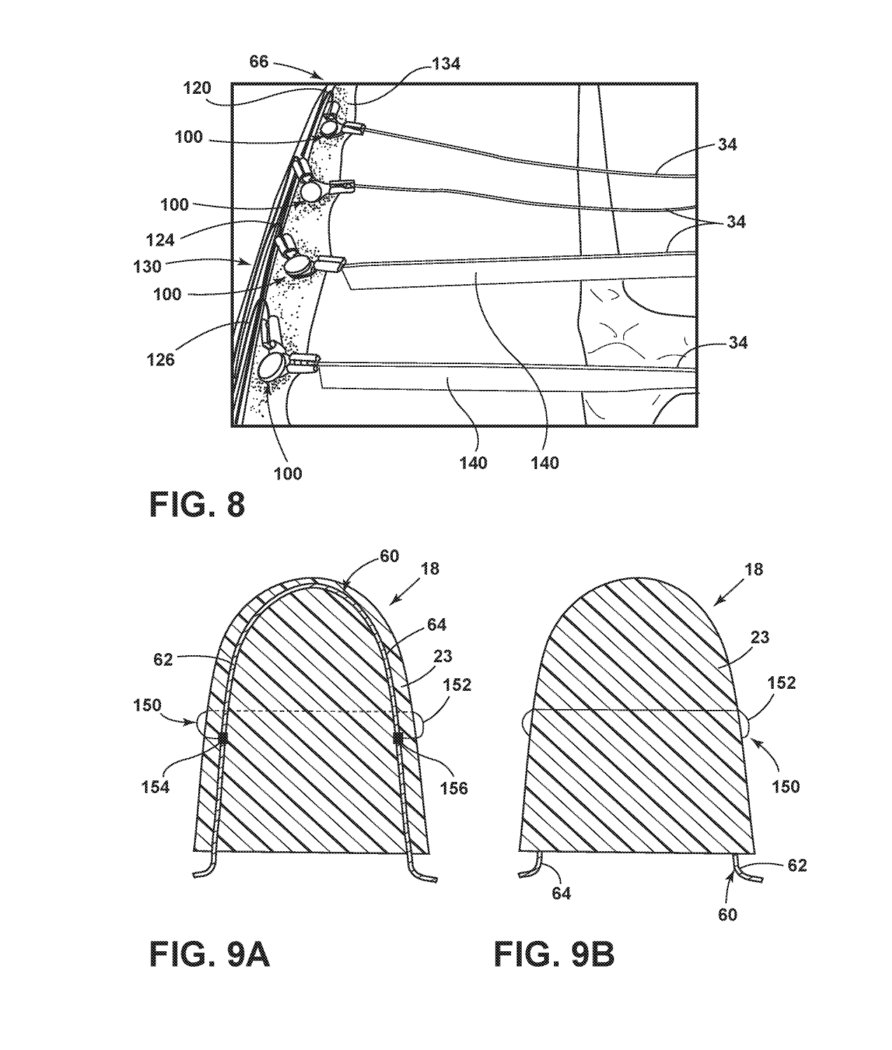

Referring now to FIG. 8, the lower two wires 34 shown therein are covered by insulating members 140. The insulating members 140 can be any kind of plastic material that preferably includes an adhesive backing, such as a polytetrafluoroethylene tape. The insulating members 140 are configured to electrically insulate the wires 34 and are contemplated to be heat-resistant members that can withstand the heat of the wires 34 in the contracted condition and isolate the heat from a seat occupant.

Referring now to FIG. 9A, the seatback 18 is shown from a front elevational view, wherein the secondary support frame 60 is positioned on a front surface of the cushion assembly 23. A support strap 150 is shown interconnecting the first and second frame members 62, 64. Specifically, the support strap 150 includes a body portion 152 having first and second ends 154, 156. In the embodiment shown in FIG. 9A, the first end 154 is coupled to the first frame member 62, while the second end 156 is coupled to the second frame member 64. Referring now to FIG. 9B, the body portion 152 of the support strap 150 is shown wrapped around the rear side of the cushion assembly 23. In this way, the support strap 150 helps to retain the first and second frame member 62, 64 in the spaced-apart relationship shown in FIG. 9A. It is contemplated that the support strap 150 is a fabric material or a plastic webbing material that is substantially inelastic to retain the first and second frame member 62, 64 in the spaced-apart relationship. Thus, the support strap 150 is configured to prevent the first and second frame members 62, 64 from caving in on a seat occupant due to the seat occupant's weight being placed on the wire array 30 interconnecting the first and second frame members 62, 64, as shown in FIG. 5. A similar support strap may be used to retain the first and second frame members 82, 84 of the secondary support frame 80 positioned within the seat portion 16 of the seat assembly 10, as discussed above with reference to FIG. 5.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A seat assembly, comprising:
first and second frame members spaced-apart from one another;
one or more wires interconnecting the first and second frame members, the wires operable between at-rest and contracted conditions; and
one or more leads operably coupled to the one or more wires, wherein the one or more leads supply a current to the one or more wires to move the wires from the at-rest condition to the contracted condition.

2. The seat assembly of claim 1, including:
respective first and second fabric members operably coupled between the first and second frame members and the one or more wires.

3. The seat assembly of claim 2, wherein each of the first and second fabric members includes an engagement end coupled to the respective frame member, and an attachment flange coupled to the one or more wires.

4. The seat assembly of claim 3, wherein each of the one or more wires includes a first end and a second end, wherein the first end is coupled to the attachment flange of the first fabric member, and further wherein the second end is coupled to the attachment flange of the second fabric member.

5. The seat assembly of claim 4, wherein the first end of each of the one or more wires is coupled to a shank portion of a first wire connector, and further wherein each of the one or more leads is coupled to a shank portion of a second wire connector.

6. The seat assembly of claim 5, wherein the first and second wire connectors include respective first and second eyelets that are coupled to one another and further coupled to the attachment flange of the first fabric member by a fastener.

7. The seat assembly of claim 6, wherein the current provided by the one or more leads is transferred to the one or more wires through the first and second wire connectors.

8. The seat assembly of claim 7, wherein the fastener includes a rivet nut.

9. The seat assembly of claim 8, wherein the first fabric member is comprised of leather.

10. The seat assembly of claim 1, wherein the one or more wires includes a plurality of wires defining a wire array substantially covering a support area defined between the first and second frame members.

11. The seat assembly of claim 10, wherein each wire of the plurality of wires is heated when the current is applied thereto.

12. The seat assembly of claim 11, wherein each wire of the plurality of wires is independently controlled by an associated lead of the one or more leads.

13. The seat assembly of claim 12, including:
a controller configured to selectively provide current to each wire of the plurality of wires through the associated lead to move each wire between the at-rest and contracted conditions in a predetermined sequence.

14. The seat assembly of claim 13, including:
insulating members comprised of a heat resistant material covering one or more of the wires of the plurality of wires.

15. A seat assembly, comprising:
a seat cover;
first and second support members operably coupled to opposite ends of the seat cover;
a wire array interconnecting the first and second support members and having multiple portions thereof operable between at-rest and contracted conditions; and
a lead array operably coupled to the wire array, wherein the portions of the wire array move to the contracted condition when a current is applied thereto through the lead array.

16. The seat assembly of claim 15, wherein the first and second support members are retained in a spaced-apart configuration by respective first and second boundary features respectively incorporated into the opposite ends of the seat cover.

17. The seat assembly of claim 15, including:
a controller configured to selectively provide current to each portion of the wire array to move each portion of the wire array independently between the at-rest and contracted conditions in a predetermined sequence.

18. A seat assembly, comprising:
a primary support frame;
a secondary support frame coupled to the primary support frame and having first and second frame members spaced-apart from one another to define a support area therebetween;
a wire array interconnecting the first and second frame members and defined by a plurality of wires that are operable between at-rest and contracted conditions; and
a lead array operably coupled to the plurality of wires and configured to provide a current thereto, wherein each wire of the plurality of wires moves to the contracted condition when the current is applied thereto.

19. The seat assembly of claim 18, wherein the plurality of wires is comprised of shape memory alloy wires that are heated when the current is applied thereto.

20. The seat assembly of claim 19, including:
a support strap having first and second ends disposed on opposite sides of a body portion, wherein the first end is coupled to the first frame member of the secondary support frame and the second end is coupled to the second frame member of the secondary support frame, and further wherein the body portion is disposed along a rear side of the seatback opposite the wire array.
